(19) United States
(12) Patent Application Publication
(10) Pub. No.: US 2004/0227752 A1
(43) Pub. Date: Nov. 18, 2004

(54) Apparatus, system, and method for generating a three-dimensional model to represent a user for fitting garments

(76) Inventors: Bland McCartha, Beaverton, OR (US); Carol Bentley, Salem, OR (US)

Correspondence Address: Brian C. Kunzler, Suite 600, 8 East Broadway, Salt Lake City, UT, 84111, US

(21) Appl. No.: 10/843,794

(22) Filed: May 12, 2004

Related U.S. Application Data
(60) Provisional application No. 60/469,724, filed on May 12, 2003.

(51) Int. Cl. G06T 15/00

(52) U.S. Cl. 345/419

(57) ABSTRACT

An apparatus, system, and method are disclosed for generating a 3D model configured to represent a user. The apparatus includes a capture module, a conversion module, and a presentation module. The capture module enables a user to capture a plurality of images of the user wearing a form-fitting body suit. The body suit includes reference points and each image includes at least three image points. The conversion module converts the images into a 3D model of the user using contours and sizing information gathered from the images and the reference points. The presentation module presents the 3D model to a user in an interface. The interface permits a user to clothe the 3D model in various garment representations. The garment representations may be pre-made or custom-fit clothing and fit the 3D model in substantially the same way that actual garments would fit the user.

### CROSS-REFERENCES TO RELATED APPLICATIONS

This application claims benefit of U.S. Provisional Patent Application No. 60/469,724 entitled “Method and System for Providing Custom-Tailored Clothing” and filed on May 12, 2003 for Bland McCartha and Carol Bentley, which is incorporated herein by reference.

### BACKGROUND OF THE INVENTION

1. Field of the Invention

The invention relates to custom-tailored clothing, more specifically, the invention relates to a system and method for providing custom-tailored clothing using a three-dimensional model of the user generated from two-dimensional images.

2. Description of the Related Art

Traditionally, custom-tailored clothing has been unavailable to most users for several reasons. As illustrated in FIG. 1, to get custom-tailored clothes a user must visit a tailor shop 100 or other clothing retailer. Typically, tailors of most custom-made clothing do not visit the user at his/her home or office. Alternatively, a user must take measurements of his/her body themselves. These measurements may be difficult to take and may be inaccurate.

In the tailor shop 100, a tailor takes many measurements of the user. Often the process of taking measurements is uncomfortable or embarrassing for the user. Then, the user considers a variety of different garment styles. The user may even try on a few off-the-rack garments to get an idea of how the custom-tailored garment will look. Once the user selects a garment style, the tailor creates a fabric pattern for the garment based on the measurements of the user. The fabric pattern is then used to cut the fabric and sew together the pieces to create a custom-tailored version of the selected garment style.

In certain instances, a user may have to revisit the tailor shop 100 to try on the custom-tailored garment so that adjustments can be made to create a more accurate fit. Visiting the tailor shop 100 multiple times may be inconvenient for the user. In addition, the tailor uses his/her training and skill to create the fabric pattern. The unique skill and experience of the tailor can dramatically increase the price of the garment.

In addition, providers of off-the rack clothing (clothing that is pre-made in standard sizes) have begun to sell clothing on-line over the Internet. Unfortunately, the clothing makers must account for a high rate of product returns. Often, the customer orders and receives the clothing, tries on the clothing, and determines that the clothing does not fit satisfactorily. So, the customer returns the product either for a different size, a different product, or for a credit. In addition, customers may find that once the clothing is delivered, the color or style is different than they have expected, especially when the clothing is tried on and compared to the customers skin, eye, and/or hair color. So, the customer returns the product. These returns can be costly for the on-line clothing retailer.

Attempts have been made to assist the customer in selecting the best size, color, and style such that returns are minimized. In particular, one potential solution presents a two-dimensional (2D) color image of the user such as a digital picture in a client browser. The user can then “try-on” various clothing over the top of this 2D image. In this manner, a customer is able to see how the clothing may or may not correlate to the skin, eye, and hair color of the customer. Unfortunately, the image is only two-dimensional. Consequently, the customer is unable to get a full 360 degree view of themselves wearing the clothing. For some customers, seeing the clothing from behind for example in a full-length mirror may be justification for returning the clothing product.

In addition, such systems are unable to provide accurate measures of the features of the user in the image such that a custom-fit garment can be produced. The 2D image does not provide sufficient information to determine such measurements as chest circumference, waist circumference, and the like.

From the foregoing discussion, it should be apparent that a need exists for an apparatus, system, and method that allows a user to identify and purchase custom-fit clothing. Beneficially, such an apparatus, system, and method would generate a three-dimensional (3D) model of the user. The apparatus, system, and method would assist the user in viewing a realistic 3D view of themselves in the clothing. The 3D view may be rotated and viewed from substantially all directions. The apparatus, system, and method would present the 3D model clothed in user-selectable representations of clothing, both off-the-rack and custom-tailored styles. The apparatus, system, and method would present the clothing on the 3D model just as the clothing would fit the customer having dimensions corresponding to the 3D model. The clothing would drape over the 3D model in the substantially the same manner as the clothing would drape, or cling, to the user. Furthermore, the apparatus, system, and method would allow custom-tailored clothing to be purchased without taking physical measurements of the customer. Consequently, a customer would be able to make an on-line purchase of clothing without ever leaving his/her residence or entering a tailor shop.

### SUMMARY OF THE INVENTION

The present invention has been developed in response to the present state of the art, and in particular, the purchasing of custom-tailored clothing and the purchase of off-the-rack clothing without physically trying on the clothing. Accordingly, the present invention has been developed to provide an apparatus, system, and method for generating a three-dimensional model configured to represent a user that overcome many or all of the above-discussed shortcomings in the art.

The apparatus to generate a three-dimensional model configured to represent a user is provided with a logic unit containing a plurality of modules configured to functionally execute certain steps. These modules in the described embodiments include a capture module configured to capture a plurality of images of a user wearing a form-fitting body suit, each image taken from different positions around the user, each image including at least three visible reference points connected to the body suit.

A conversion module is configured to convert the plurality of images into a three-dimensional model of the user by determining contours of the user from the plurality of images and the corresponding reference points in each image. A presentation module is configured to present the three-dimensional model to the user in an interface that allows the user to clothe the model in a plurality of selectable garment representations, the garment representations fitting on the model based on the respective sizes of the three-dimensional model and the selectable garment representations. The presentation module may allow the three-dimensional model to be rotated to display different sides of the three-dimensional model including any selected garment representations. The presentation module may include an interface that allows a user to clothe the model in a plurality of selectable garment representations. The user may also make minor adjustments to the garment representation by moving adjustment points associated with the model.

The apparatus, in one embodiment, is configured to determine the contours and generate the three-dimensional model using a commercially available software package. In certain embodiments, the plurality of images are converted from a corresponding set of photographic film images captured using a disposable camera.

In addition, a representation conversion module may be configured to generate a fabric pattern sized to proportionally correspond to the one or more selected garment representations on the three-dimensional model, wherein the fabric pattern is printed to minimize fabric waste and configured such that a seamstress can follow the pattern and make the corresponding garment. The garment representations may represent either custom-tailored garments or off-the-rack standard sized garments. The fabric pattern may be sent to a tailoring facility where a seamstress may make the custom-tailored garment.

A method of the present invention is also presented for providing custom-tailored clothing. The method in the disclosed embodiments substantially includes the steps necessary to carry out the functions presented above with respect to the operation of the described apparatus. In one embodiment, the method includes sending an image capture kit to a customer for capturing a plurality of two-dimensional images of a user wearing a form-fitting body suit having a plurality of reference points, each image taken within about the same horizontal plane and from a different angle circumscribing the user.

The method also may include receiving the plurality of images from the customer and rendering a three-dimensional model configured to represent the customer from the images, the three-dimensional model comprising the actual size, likeness, and proportions of the user wearing the body suit, and presenting the three-dimensional model dressed in a representation of a user-selected garment to the customer, the representation of a user-selected garment draping naturally over the three-dimensional model in accordance with the proportions of the representation of a user-selected garment.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating conventional methods for purchasing custom-tailored clothing;

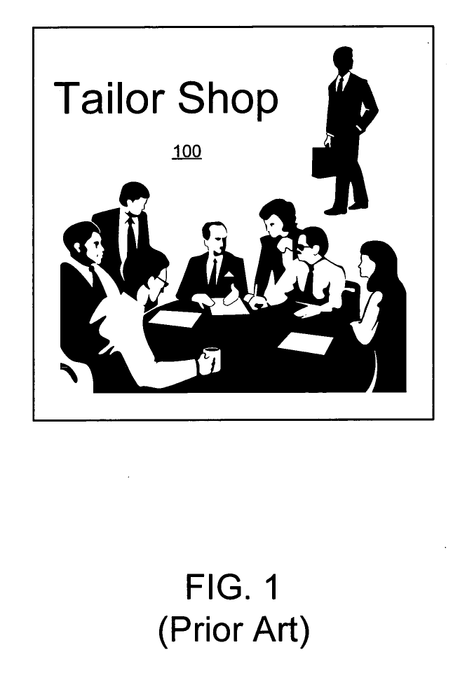

FIG. 2 is a logical block diagram of an apparatus in accordance with the present invention;

FIG. 3A is a schematic block diagram illustrating one embodiment of a capture module in more detail;

FIG. 3B is a user interface illustrating one embodiment of an interface for viewing a 3D model of a user;

FIG. 4 is a schematic block diagram illustrating one embodiment of an image conversion module;

FIG. 5 is a schematic flow chart diagram illustrating one embodiment of a method for providing custom-tailored clothing in accordance with the present invention; and

FIG. 6 is a schematic flow chart diagram illustrating one embodiment of a method for purchasing custom-tailored clothing without visiting a tailor or clothing retailer in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

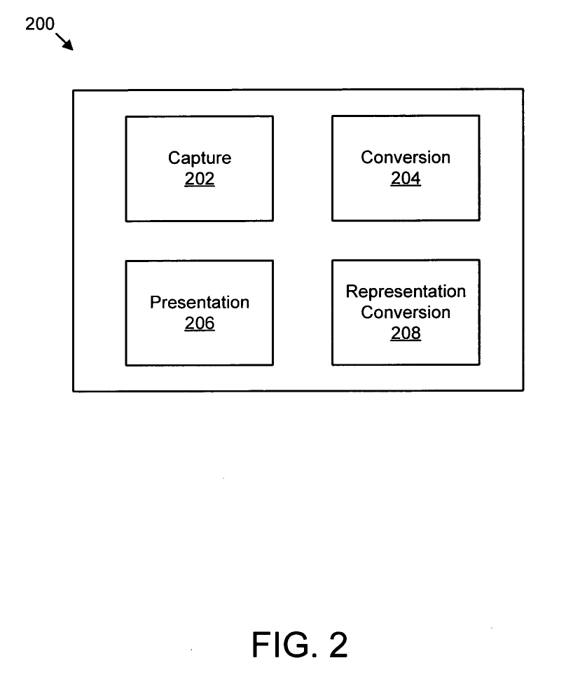

Referring now to FIG. 2, an apparatus 200 for providing custom-tailored clothing according to one embodiment of the present invention is illustrated. The apparatus 200 includes a capture module 202, a conversion module 204, a presentation module 206, and a representation conversion module 208.

The capture module 202 captures a plurality of images of a user wearing a form-fitting body suit. Preferably, the capture module 202 allows for the images to be captured directly. Alternatively, the capture module 202 may include other systems and components for producing the images from conventional film. Preferably, the capture module 202 includes all the elements necessary for a user to create the images from within the privacy of their own home.

In one embodiment, the capture module 202 is a mailable kit that may arrive on a user's doorstep. The kit may include all the elements necessary to capture and preserve a plurality of images of the user wearing just the form-fitting body suit. Of course, the user may provide the images using his or her own image capture device. For example, the user may use his/her own film camera, digital camera, video camera, and the like. Preferably, the capture module 202 is inexpensive and convenient. In one embodiment, the kit includes a disposable film camera for capturing the plurality of images. The user need not to visit a tailor shop 100 to order and purchase custom-tailored clothing. Furthermore, the user does not have to be physically measured to obtain custom tailored clothing.

The capture module 202 provides the plurality of images to the conversion module 204. The conversion module 204 converts the plurality of images into a three-dimensional model of the user. Preferably, the images and corresponding three-dimensional model include the user's head, hands, and feet with life-like representation of the user in texture and coloring.

In one embodiment, the conversion module 204 determines the contours of a user from each of the images. The conversion module 204 may detect the contour of the user in the image by using well known image processing techniques such as boundary location. Next, the surface between the contours is interpolated in three dimensions. Consequently, the 3D model includes substantially the same contours as the user. The process of detecting contours and interpolating the surface between them is repeated until all the images are processed and a 3D model is generated.

The 3D model may be stored as data within a computer. In certain embodiments, the image conversion module 204 comprises readily available software programmed to combine a plurality of images into a 3D model.

The presentation module 206 presents the 3D model to a user. The 3D model may be presented within an interface such as a web browser or other software program. Preferably, the 3D model is dressed in a garment that is selected by the user. A variety of garment styles may be available to a user including shirts, pants, skirts, blouses, dresses, suits, and the like. The user selects a garment style and the presentation module 206 fits the garment style to the three-dimensional model. The garment is mapped onto the 3D model in accordance with such features as arm length, hem line, neck line, a user's height, and the like.

In other words, the 3D model is “clothed” in one or more selectable representations of garments. The presentation module 206 fits the garment representations onto the 3D model based on the size of the 3D model and the size of the garment represented by the garment representation. If the selectable garment is custom-tailorable, not off-the rack, the presentation module 206 adjusts the size of the adjustable features of the garment to properly fit the 3D Model.

For example with pants, the presentation module 206 may adjust the inseam and side seam (outside length of the pant leg) to a proper length based on the height of the user and the position of the user's ankles and knees. The garment representation is sized to properly fit the 3D model based on the size of the parts of the 3D model that are “clothed” within the garment representation. Additionally, other measurements that are typically changed on a garment may be changed by the presentation module 206. These measurements may include neck size, hem line, sleeve length, and the like.

The mapped garment representation may not be adjusted, however, for other features such as girth, bust size, chest size, and the like. Garment features that a tailor typically does not change. The garment is mapped onto the 3D model such that features like girth, bust size, chest size, and the like affect the look of the garment draped over the 3D model.

If the selectable garment is of a standard size, off-the rack, the presentation module 206 makes no adjustments to features of the garment representation. Consequently, loose, tight, long, and short sections of the garment representation are revealed in relation to the 3D model once the garment representation is placed on the 3D model of the user.

In this manner, the user is provided with a realistic view of how they would look dressed in the garment. In addition to the garment style, a user may select shoes and other accessories that are placed on the 3D model.

In one embodiment, the garment is mapped onto the 3D model using texture mapping. Alternatively or in addition, a 3D representation of the user-selected garment is generated. The garment representation is produced based on the style of the garment, the fabrics to be used, and other such factors. Consequently, the garment representation fits, conforms, and drapes over the 3D model just as a custom-made garment placed on the user.

In certain embodiments, the mapping of the garment representation onto the 3D model is accomplished in part using markers on the 3D model. The markers may identify particular points on the 3D model that affect how portions of a garment representation are sized. For example, a hem line is set relative to the position of a person's knee. Accordingly, the 3D model may include a marker for the location of the user's knees such that the hem line can be properly sized. In one embodiment, the markers are in substantially the same positions as reference points that are connected to the form-fitting body suit, discussed in more detail below.

In certain embodiments, the presentation module 206 includes one or more adjustment points that allow a user to increase or decrease certain measurements of the garment to accommodate features such as girth, bust size, chest size, and the like. The adjustment points may be standard adjustment points or unique to each garment style. Changing adjustment points may alter the look and design of the garment as well as changing sizes of standard features. In this manner, the presentation module 206 allows a user to “tailor” the garment according to his/her preferences. In certain embodiments, the adjustment points allow for minor changes in the design of the garment. For example, a user may use adjustment points to change the hem line or neck line for the garment.

Preferably, the presentation module 206 is implemented as software in a client-server environment. For example, the presentation module 206 may comprise a plug-in or applet that executes in a browser over the world wide web. Access to the presentation module 206 and/or a user's 3D model may be restricted using a login username and password to protect a user's privacy. Alternatively, the presentation module 206 is a local software product that runs on a user's personal computer.

The representation conversion module 208 converts the user-selected garment representation into a fabric pattern suitable for making the garment. The measurements for the fabric pattern are calculated using the garment representation produced in the presentation module 206. Of course, the fabric pattern is sized to match the sizes and proportions of the garment representation such that automatic size changes made by the apparatus 200 or manual adjustments made by the user are reflected in the fabric pattern. The fabric pattern includes templates and instructions sufficient to allow a regular seamstress to cut the fabric and sew the pieces together to form the garment.

Preferably, the fabric pattern is formatted for printing on paper sized to correspond to the width of the fabric to be used for the garment. Alternatively, the fabric pattern may be printed directly onto the back side of the fabric. The fabric pattern may be organized as a set of instruction for a flatbed plotter, large-width printer or other similar printing device. In yet another embodiment, the fabric pattern may be formatted as instructions for controlling computer-aided-machine (CAM) tool to cut the pattern directly from the fabric.

In certain embodiments, a user may also select the type of fabric for the garment. The fabric type may affect how the garment looks on the three-dimensional model. The fabric type may also affect how the representation conversion module 208 lays out the fabric pattern. Preferably, the representation conversion module 208 lays out the pattern such that minimal fabric is wasted.

In addition, the fabric type may affect the width of the fabric available for laying out the pattern. For example, conventionally, fabric is available in widths of thirty-six, forty-five, or sixty inches. Certain fabric types are associated with certain fabric widths. The representation conversion module 208 adjusts the layout of the fabric pattern based on the width of the selected fabric type. In addition, fabric types may include different patterns such as pin stripes, plaid, or the like. The representation conversion module 208 lays out the pattern such that the pattern of the fabric corresponds to the pattern defined by a selected fabric type.

Typically, off-the rack clothing is made with extra material to allow for alterations after a customer tries on the clothing and is measured at a retail store. This material is usually hidden on the inside of the clothing. Often such extra fabric is unused and thus wasted. Similarly, when a tailor lays out a pattern for custom-tailored clothing, the tailor may leave extra to material to account for measurement errors. The expense of the extra material is passed on to the customer without the customer obtaining any direct benefit.

In contrast, in certain embodiments, the representation conversion module 208 is configured to lay out the fabric pattern in such a manner that minimal fabric is wasted. For example, certain pieces of the clothing may be shifted and re-oriented until the minimum amount of fabric is being used. Of course, the representation conversion module 208 may also provide some extra material to allow for growth and subsequent alterations after the customer uses the clothing for a period of time.

Preferably, the representation conversion module 208 comprises well known and widely available software products that produce fabric patterns given a certain input such as measurements and garment design, a 3D model, a set of data points, or a Computer Aided Design (CAD) file. Such software may include PatternMaster available from Wild Ginger Software, Inc. of Nashville, Tenn., in its current form or with minimal revisions. Of course other fabric pattern making software may also be used to implement the representation conversion module 208 in different embodiments.

Preferably, in certain embodiments, the apparatus 200 integrates currently available software to implement the conversion module 204 and the representation conversion module 208. Consequently, existing software includes fewer programming bugs and minimizes the costs associated with implementing the apparatus 200. In this manner, the apparatus 200 may be implemented for minimal expense and still provide a full set of features for producing custom-tailored clothing.

In certain embodiments, the representation conversion module 208 sends the fabric pattern to a tailoring facility that makes the garment based on the fabric pattern. In addition to producing a fabric pattern for the garment representation, the representation conversion module 208 may also generate a work order for making the garment. The work order may include such information as the name of a purchaser of the garment, shipping information, and special instructions. Special instructions may include instructions for a monogram on a shirt pocket, or the like.

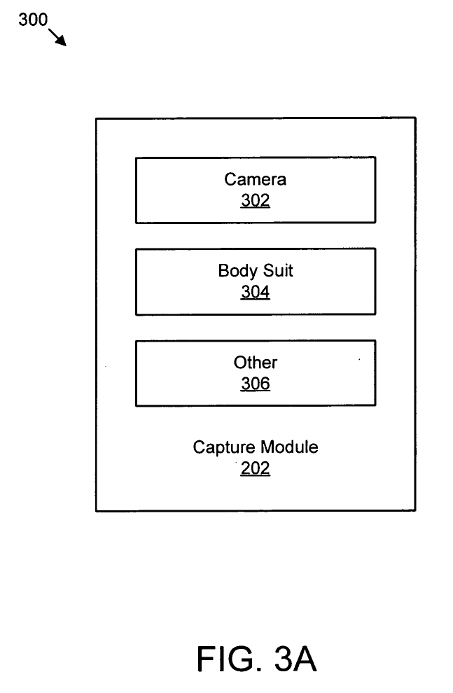

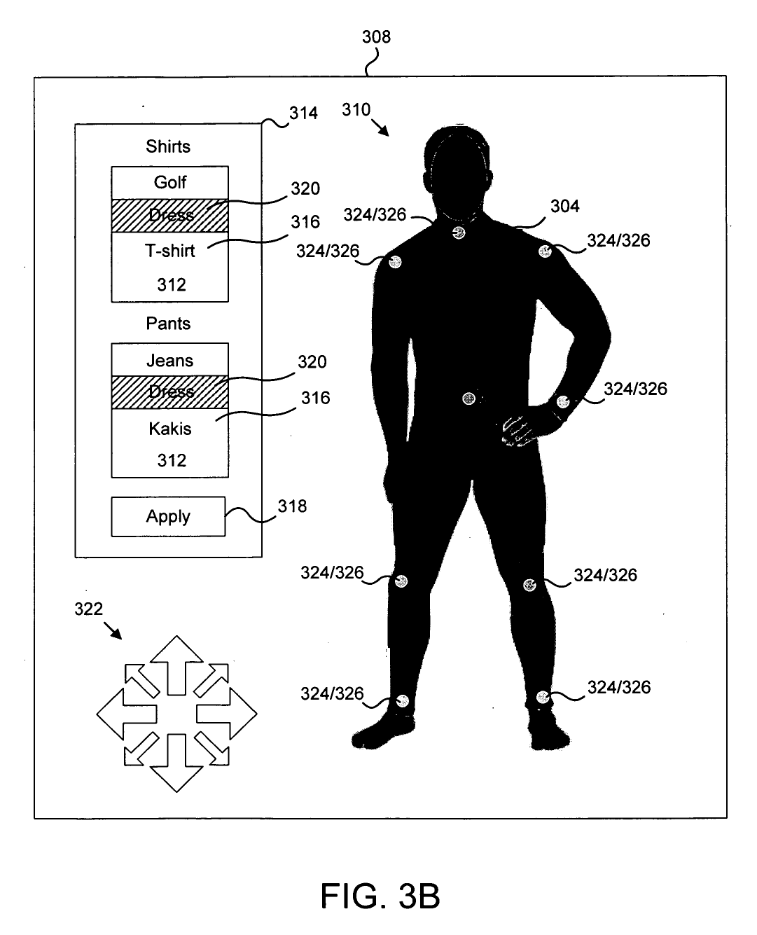

Referring now to FIG. 3A, the capture module 202 is illustrated in more detail. In one embodiment, the capture module 202 comprises an image capture kit 300 that may be sent to a customer. The image capture kit 300 preferably includes the components needed to capture a plurality of two-dimensional (2D) images such that a 3D model can be produced to allow the apparatus 200 to provide a customer with custom-tailored clothing and/or a virtual (on-line) “dressing room.”

Preferably, the capture module 202 includes a camera 302 and a form-fitting body suit 304. Typically, with the help of another user, the user takes a plurality of pictures of the user wearing only the body suit 304 from a variety of angles. The camera 302 is aimed at the mid-section of the user and is far enough away to include all of the user. Next, a picture may be taken of the user approximately every fifteen degrees about a circle circumscribing the user in a standing position. Preferably, the camera 302 remains in about the same horizontal plane with respect to the user. A top view picture may also be taken. In addition, side and front view pictures may be taken with the user's arms extended forward and out from his/her sides. In one embodiment, about twenty-four pictures are taken of the user.

In certain embodiments, a user uses his/her own camera 302 instead of the camera 302 provided. Alternatively, no camera 302 is included in the kit 300, the user is expected to use his/her own. The camera 302 may be a conventional film camera, a digital camera, a disposable camera, or the like. Alternatively, a digital or analog video camera may be used to capture images of the user. Consequently, in certain embodiments, the capture module 202 includes a processing center for converting film or video pictures into a plurality of images. Preferably, the images are in a digital format such as Bitmap (BMP), Graphics Interchange Format (GIF), Tagged Image Format (TIF), and the like.

Preferably, the images are taken of the user wearing only the body suit 304. The body suit 304 conforms to the contours of the user's body without changing the shape of the user's body. Alternatively, the user may wear under garments beneath the body suit 304. Typically, the images are taken in the privacy of a user's home and are kept confidential to prevent unauthorized use of the images.

The capture module 202 may include three general sizes of body suits 304 such as small, medium, and large. The three sizes of body suits 304 are sized such that substantially any user will comfortably fit into one of the body suits 304. The body suit 304 is made from a stretchable fabric such as nylon or the like. The body suit 304 should fit a user and conform to all of the contours of the user's body without changing the shape of the user's body.

Preferably, the body suit 304 covers a user's body from the neck down to the ankles and out to the wrists. The images, however, include the user's head, feet, and hands. To facilitate processing of the images, the body suit 304 may be of multiple bright colors such that the form of the body suit 304 is readily detectable in a variety of lighting and background conditions. Alternatively, the body suit 304 may cover a portion of the body such as the upper half or lower half. In yet another alternative, the body suit 304 may comprise two pieces a top and a bottom.

The image capture kit 300 may also include various other 306 components to facilitate capture of high quality and useable images as well as components that facilitate selection and ordering of custom-tailored clothing. Examples of other components 306 may include one or more sets of fabric swatches, a turn-table, or a return-addressed, postage paid shipping container.

The fabric swatches may include pieces of all the fabrics available for ordering a custom-tailored or off-the rack garment. The fabric swatches allow a user to get a feel for what kind of fabric may be used and how that fabric looks and feels. Familiarity with the fabric that a user orders for the garment facilitates customer satisfaction with the garment that is ordered.

The turn-table may be used to facilitate capturing of the plurality of images. Preferably, the images comprise a sequential set of images taken at different angles in a circle circumscribing the user in a standing position. The turn-table may be marked with a plurality of angles. Initially, the camera 302 may be set up in a stationary position such as on a tripod. Next, a first image may be captured as the user stands facing the camera 302. Then, the user may rotate on the turn-table to a subsequent angle in relation to the fixed position of the camera 302 for a second image capture. This process may be repeated until all the camera film is exposed, a certain minimum set of images is captured, or images are taken for all the angles marked on the turn-table. To facilitate rendering of an accurate 3D model, the plurality of images are ordered and taken in sequential fashion at various angles about the user.

Preferably, a user uses the image capture kit 300 to capture 2D images and identify fabric types. The images may then be returned to a manufacturer. In one embodiment, the images are on conventional film and the capture kit 300 with at least the exposed film is sent to the manufacturer. In one embodiment, the capture kit 300 includes return mailing and postage information to facilitate returning the kit 300.

Alternatively, the user may send the images to the manufacturer electronically using conventional digital means such as email, File Transfer Protocol (FTP), CD-ROM, diskette, or the like. Furthermore, the images may be sent to a retailer, manufacturer, tailoring facility, or the like. With the images sent, the image capture kit 300 may be disposed of by the user or optionally returned.

As discussed in more detail below, with the images of the user, a conversion module converts the images into a 3D model of the user in the body suit 304. The 3D model is generated using reference points on the body suit and determination of the contour of the user in each image. This 3D model may be used to try-on pre-made garments or fit custom-tailored garments for the user. The 3D model is preferably proportional in scale to the user.

FIG. 3B illustrates one embodiment of an interface 308 provided by a presentation module 206 (See FIG. 2). The interface 308 displays a 3D model 310 of the user dressed in the body suit 304. Preferably, the 3D model includes the head, face, feet, arms, and hands of the user. Optionally, in certain embodiments a user may determine whether the head, feet, and/or hands are displayed. The interface 308 is configured to allow a user to clothe the model 310 in a plurality of selectable garment representations 312.

The kinds and types of selectable garment representations 312 may vary depending on the gender of the user and/or offerings made available by the manufacturer or supplier. For example, selectable garment representations 312 may include shirts, pants, dresses, evening where, suits, and the like. In addition, selectable garment representations 312 may include accessories such as shoes, belts, hats, hand bags, scarves, gloves, and the like.

The interface 308 may include a set of controls 314 that allow the user to choose from a selection of selectable garment representations 312. The set of controls 314 may include list boxes 316 and command buttons 318. Using a mouse or other navigation device, a user may select a garment representation 312 for each of the list boxes 316. The interface 308 may highlight each selection 320. Garment configuration rules may control whether multiple selections can be made. For example, whether a dress can be selected with pants or not.

Once one or more garment representations 312 are selected, a user may issue a user command to display the selected garment representations 312 on the 3D model 310. In one embodiment, the user selects an “Apply” button 318. Alternatively, the interface 308 may display a selected garment representation 312 on the 3D model 310 in response to a double-click of the selection 320.

In certain embodiment, the interface 308 includes a set of arrow buttons 322. The arrow buttons 322 permit the user to rotate the 3D model 310 about a vertical and/or horizontal axis centered at about the center of the 3D model 310. In certain embodiments, a user may also rotate the 3D model 310 about diagonal axis. In this manner, once a selected garment representation 312 is on the 3D model 310, a user may rotate the 3D model in various directions to view different sides of the 3D model 310. The user is able to get a “full-mirror” 360 degree view of themselves in the garment.

Preferably, the body suit 304 includes a plurality of reference points 324. In one embodiment, the reference points 324 are buttons of about one inch in diameter. The buttons are metallic colored or another suitable color such that the buttons are readily detectable in the images taken of the user.

The reference points 324 enable the generation of an accurate 3D model 310. As discussed more below, the reference points 324 are strategically placed to enable determination of certain lengths, widths, and heights for generating the 3D model 310. Once generated, other data points or structures defining the 3D model 310 may be used to size and display a selected garment representation (not shown) on the appropriate part of the 3D model 310.

In one embodiment, the garment representations correspond to particular designs of garments. The garment representations may comprise 3D models or objects of real garments including cut, style, color, fabric, and the like. The garment representations may represent pre-made garments having a standard size or custom-tailored garments in which certain size characteristics can be modified to fit a user.

If the garment representation is a pre-made garment, the presentation module 206 displays the garment representation on the 3D model 310 without changing any of the sizes of the garment representation. Consequently, the garment representation clings, drapes, or hangs on the 3D model 310 in the same way that this size of actual garment would cling, drape, or hang on the user because the size of the garment representation and 3D model 310 are proportional to the size of the pre-made garment and user.

If the garment representation is a custom-tailored garment, the presentation module 206 adjusts certain size parameters of the garment representation. Preferably, the size parameters correspond to substantially the same parameters that would be adjusted in an actual custom-tailored garment.

For example in a suit coat, custom tailoring typically allows for the width of the shoulders to be fit to the user. Similarly, the presentation module 206 adjusts the width of the garment representation to comfortably fit the width indicated by the 3D model 310. Other size parameters, such as lapel length, may not be custom tailorable.

Once the presentation module 206 has altered the garment representation, the interface 308 displays the garment representation on the 3D model 310. Consequently, the garment representation clings, drapes, or hangs on the 3D model 310 in the same way that a custom-tailored garment of the type selected would cling, drape, or hang on the user.

Displaying the garment representation on the 3D model conceals the body suit 304 just as the actual garment would on the user. Consequently, a neck line on the 3D model corresponds to where the neck line would run on the user. In one embodiment, customizable and/or traditionally non-customizable size parameters for a garment may be adjustable by the user.

For example, the interface 308 may include a plurality of user-selectable adjustment points 326. In one embodiment, the adjustment points 326 correspond in position and size to the reference points 324, although this is not necessary. The adjustment points 326 may be visible through the garment representations.

Certain adjustment points 326 correspond to regular custom tailoring parameters. While other adjustment points 326 may correspond to parameters that change the style of the garment, for example lapel length.

As mentioned above, one adjustment point 326 may correlate to the neck line. Preferably, the interface 308 allows a user to select an adjustment point 326 and move the adjustment point 326 to change the corresponding size parameter. The interface 308 may re-draw the garment representation as the adjustment point 326 is moved such that the user can see how the change looks relative to the 3D model 310.

Consequently, the user can set the hem line or neck line where desirable. In addition, the user can alter certain design characteristics of the garment representation to design his/her own version. This flexibility is made possible because of a proportional and realistic 3D model 310.

The present invention provides a simple, inexpensive way to generate an accurate 3D model of a user for use in making custom-tailored garments. Conventionally, a body scan of a user may be made using complex and expensive whole body scanning machines. To use the machine, a user must visit a tailor shop 100 or similar facility. Furthermore, use of the machine requires that the user wear minimal clothing. The capture module 202 allows a user to provide images needed to produce a three-dimensional model without using expensive equipment that requires the user to leave their home or to be partially dressed in a public place.

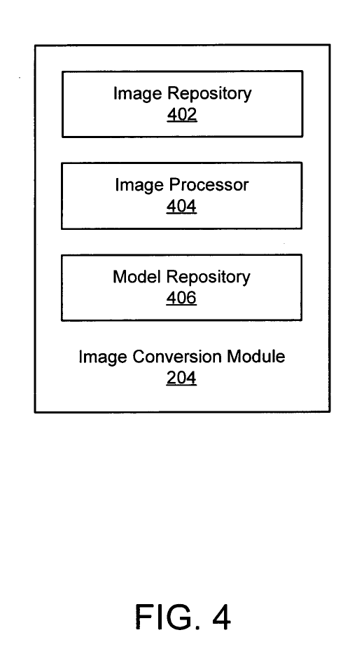

FIG. 4 illustrates the image conversion module 204 in more detail. The image conversion module 204 includes an image repository 402. The image repository 402 stores the plurality of images produced of the user in the body suit 304. Preferably, the image repository 402 is a database. The image repository 402 may store additional information related to a user. For example, the user's name, contact information, billing information, and the like may also be stored. Alternatively, the images may be stored in various data structures. In one embodiment, the images are stored in files organized into directories that are associated with each user.

In certain embodiments, the plurality of images are captured on photographic film from a conventional or disposable camera. Consequently, the image repository 402 may be configured to develop the photographic film and produce digital images that correspond to the images on the photographic film. The digital images are stored in the image repository 402.

The image processor 404 combines the images together to create a 3D model 310 (See FIG. 3) of the user. Preferably, the image processor 404 comprises a conventional, commercially available software package such as “3D Photo Builder Professional” from Anything3D of San Francisco, Calif. Other widely available software such as Computer Aided Design (CAD)/Computer Aided Modeling (CAM) products available from AutoDesk, Inc. of San Rafael, Calif.

This software analyzes each image and combines the information from the images to create a three-dimensional model of the user that includes the color and features of the user. In addition to combining the visual information such as color, the software uses the reference points 306, at least three in each image, to determine properly scaled size information. Preferably, the reference points 306, or buttons, are automatically detected by the image processor 404. Alternatively, an operator may manually identify the reference points 306 in each image.

The reference points 306 are strategically positioned on the body suit 304 such that in each image at least three reference points 306 are visible. Furthermore, one reference point 306 is near the waist, one is near the feet, and one is near the head of the user. For example, the body suit 304 may include a reference point 306, or button, on each shoulder, in the middle of the upper back, at each knee and elbow, over the bellybutton, and the like.

Consequently, the reference points 306 are positioned in the body suit 304 so as to align with specific parts of the body of the user. By determining where the reference points 306 are in 3D space, sizes and distances between the reference points 306 can be calculated. Certain reference points 306 can then be used to define where joints and other garment measurement points are on the user. Because at least three reference points 306 are visible in each image and the size of the reference points 306 is known, the software uses basic trigonometry and triangulation to find the position of each reference point 306.

The reference points 306 may be referred to as calibration buttons because the image processor 404 uses the calibration buttons to determines sizes and distances between objects in the image. The actual size of the calibration buttons is known. For example, the buttons may be one inch in diameter. The image processor 404 determines the size of each calibration button in each image. The actual calibration button size is then compared to the measured size of the calibration buttons to determine a factor that represents the amount of distortion of the calibration button in the image. The factor may be used to derive the actual heights and widths of the user from each image.

The factor may be used to determine other information about the image such as the distance of the camera from the user, the angle of the camera with respect to the user, parallax error information, as well as the height of the user. Parallax error represents a difference in the distance between an observer and a subject when the subject is observed from two different angles. Parallax error may be determined using two images.

Using the three reference points 306, parallax error, and triangulation, the software defines one or more vertical planes that contain the reference points. These planes may then be used to determine the depth of the user, size of the user in the z-direction into and out of the image. In addition, preferably, the same software analyzes each image to identify the contour or outline of the user.

Next a subsequent image is processed in a similar manner. Preferably, the image processor 404 processes a series of image captures sequentially at different angles with respect to the user. These images are then compared such that 3D information is interpolated to fill in and complete a 3D model of the user.

Furthermore in certain embodiments, the image processor 404 may divide °) each image of the user into lateral and horizontal slices. The actual lengths and widths for the user are derived using the factor, mentioned above. In this manner, the image processor 404 generates a plurality of points corresponding to each slice.

By combining these points with the points generated from the other images, a plurality of smooth contours may be interpolated. The contours are combined to form a 3D model 310 of the user. The reference points 306 provide sufficient accuracy in generating the 3D model 310. The 3D model 310 proportionally represents the actual size likeness and proportions of the user wearing the body suit 304. Such precision enables proper measurements to be computed for custom-tailored garments without taking actual physical measurements.

The software to produce the 3D model is commercially available. The generation of the 3D model may be referred to as rendering. Again because at least three reference points 306 are visible, this software does not require specific lighting conditions when the images are captured, nor is a particular camera position required. Preferably, each image is taken within about the same horizontal plane. This means that the camera remains within about substantially the same horizontal plane as each image is captured.

Preferably, the image processor 404 includes markers in the 3D model 310 that represent where the reference points 306, or calibration buttons, are located on the user in the images. These markers may be used by the presentation module 206 to properly map a garment representation onto the 3D model 310. For example, markers near the knee of the user may be used to set the hem line for a skirt. A marker on the front of a user's neck may be used to place the neck line for the garment representation.

The 3D model 310 generated by the image processor 404 is preferably stored in a model repository 406. Preferably, the model repository 406 is a database. In one embodiment, the image repository 402 and model repository 406 may comprise the same database. Preferably, the 3D model is stored as a plurality of x, y, z coordinate tuples. The coordinate tuples may be connected by contour lines to present the three-dimensional model. In another embodiment, the 3D model 310 is represented by a wire frame that defines both horizontal and vertical contours of the user.

Alternatively, a set of coordinate pairs may represent a polygon. These sets of coordinate pairs may be stored for a plurality of polygons that cooperate to present a 3D model 310 of the user. Using the stored 3D model 310, a user may repeatedly see different garment types mapped onto the 3D model 310.

The following schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

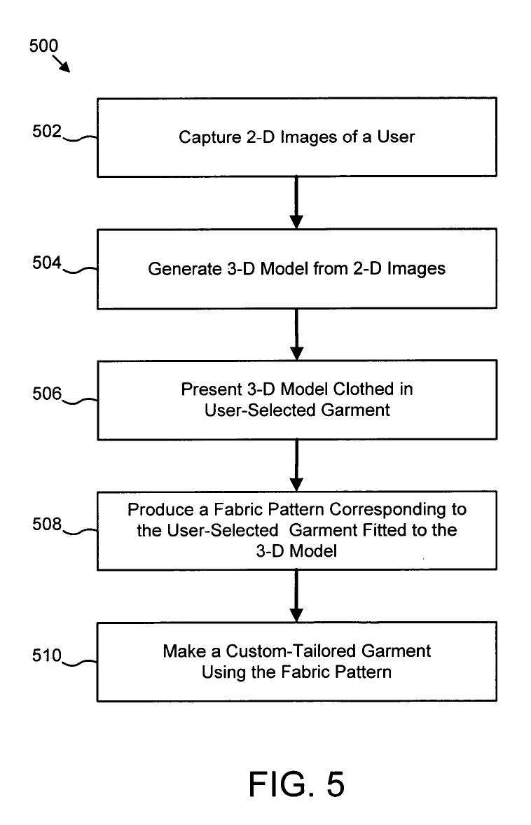

Referring to FIG. 5, the present invention includes a method 500 for providing custom-tailored clothing. First, 2D images of a user are captured 502 using a camera 302. As mentioned above, the camera 302 may be a conventional camera, a digital camera, a video camera, or the like. The user is dressed in the body suit 304 as described above. Preferably, the images are taken from successive angles circumscribing the user. In one embodiment, an image capture kit 300 (See FIG. 3) is sent to a potential customer/user.

Next, a 3D model 310 of the user is generated 504 using the 2D images. In certain embodiments, the images may be received at a processing center that converts film images to digital images. The digital images are collected in an image repository 402. As described above, the 3D model 310 is created from the images by the image processor 404. In one embodiment, the 3D model 310 is rendered using the plurality of images. The 3D model 310 is stored in the model repository 406.

Then, a user is presented 506 with the 3D model 310 clothed in a user-selected garment. Preferably, the garment is mapped onto the 3D model 310 in accordance with the design of the garment. In addition, the garment fits and drapes over the 3D model 310 in substantially the same manner as the garment would on the user. Preferably, a user may select a plurality of garments and see each garment mapped onto the 3D model 310. In this manner, a user is able to conduct a “virtual fashion show” of many garments that can be custom-tailored for the user as well as pre-made garments.

The 3D model 310 within an interface 308 such as that illustrated in FIG. 3B may be presented within a web browser or standalone client software program executing on the user's home computer. In addition, in certain embodiments, once a plurality of images are provided, a user may view the 3D model 310 in various garment representations over the Internet.

If the user decides on a selected garment, the user may complete a sales transaction for the selected garment over the Internet. If the selected garment is pre-made and order may be filled and the selected garment shipped to the user.

If the selected garment is a custom-tailored garment, a fabric pattern is produced 508 that corresponds to the user-selected garment. The pattern includes sizes and measurements that correspond to the three-dimensional model of the user. The fabric pattern may be printed or formatted for printing at a tailoring facility. The fabric pattern may account for patterns on the desired fabric such as pin-stripes, plaid, or the like. Alternatively, the fabric pattern may comprise a set of instructions for a Computer Aided Machine (CAM). The CAM may optionally cut material directly according to the fabric pattern.

Finally, a custom-tailored garment corresponding to the user-selected garment is made 510 based on the fabric pattern. A minimally skilled seamstress or laborer may make the custom-tailored garment because the fabric pattern has already been generated. Consequently, making the garment may be very inexpensive. Optionally, the custom-tailored garment may be shipped directly from the tailoring facility to the customer.

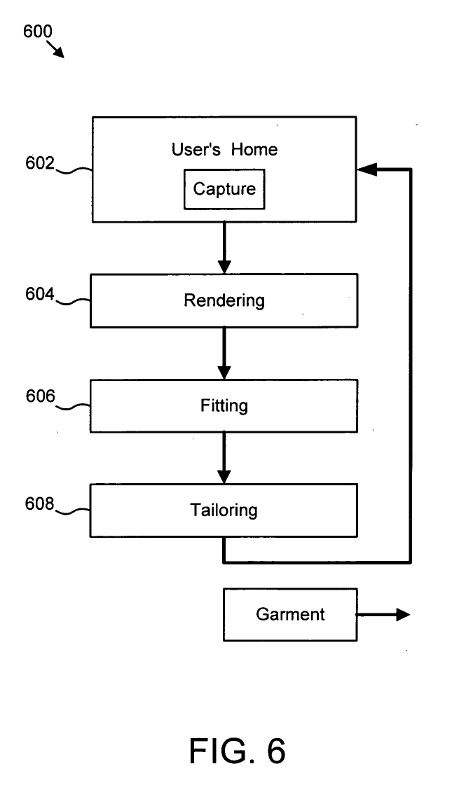

Referring now to FIG. 6, the present invention also includes a method of providing custom-tailored clothing without requiring the user to be physically measured. First, the user may be sent a kit 300 that allows the user to capture 602 a plurality of images of the themselves wearing the body suit 304. The kit 300 may include a set of instructions, small, medium, and large body suits 304, and a disposable camera 302.

In certain embodiments, the kit 300 includes a plurality of fabric swatches that allow a user to feel the different fabrics that may be used to produce a custom-tailored garment. Preferably, the user receives the kit and generates the images in his/her home. The kit may be pre-addressed and postage paid for delivery to a processing facility. The processing facility may develop the film and generate a plurality of digital images. The processing facility may also create a 3D model 310 of the user and store the 3D model 310 on a server.

Next, the user may logon to a website to view the 3D model 310. The website may include security such as a username and password to protect a user's privacy. The website may access the model repository 406 to render 604 the three-dimensional model in a web browser.

The website may also include a fitting interface 308 that allows the user to fit 606 a user-selected garment style to the 3D model 310. The interface 308 allows a user to see how the garment will look on them. The interface 308 may allow the user to change the fabric type, color, or make minor garment design adjustments by changing user-selectable adjustment points.

Once a user has determined the garment style they would like to purchase, the website may collect information to complete a transaction for the custom made garment. For example, contact information and billing information about the user may be collected.

Once the transaction is completed, the garment is tailored 608. As mentioned above, a garment representation sized to fit the 3D model 310 is converted into a fabric pattern. Preferably, the garment representation is converted to a fabric pattern using conventional software packages. For example, computer-aided design (CAD) software packages presently exist that will take a CAD image, such as a CAD garment representation, and convert the CAD image into a fabric pattern. One example of such a software package is Fashion CAD, available from CAD CAM Solutions, of Subiaco, Western Australia.

The fabric pattern is provided to a tailoring facility. In one embodiment, the fabric pattern and/or a work order may be sent to a remote tailoring facility such as a textile facility in Hong Kong. The fabric pattern may be sent as an attachment to an email message. The tailoring facility makes the garment based on the fabric pattern. Once finished, the garment may be shipped directly to the user. Consequently, the user may order and receive custom-tailored clothing without having physical measurements taken, or even leaving his/her home.

In summary, the present invention provides a system and method for providing custom-tailored clothing for a user. The present invention uses very inexpensive equipment to capture images of a user and converts these images into a realistic 3D model using calibration buttons connected to a body suit worn by the user. Physical measurements of the user are not required. The images may be taken in the privacy of a user's home. The user may order, select, and receive the custom-tailored clothing without ever entering a tailor shop 100. Furthermore, the present invention automatically generates a fabric pattern for a user-selected garment, thus eliminating the need for an expensive master tailor. In addition, once a 3D model is created for a user, the user may readily order additional custom-tailored clothing or pre-made clothing using the same 3D model.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for generating a three-dimensional model configured to represent a user, the apparatus comprising:
a capture module configured to capture a plurality of images of a user wearing a form-fitting body suit, each image taken from different positions around the user, each image including at least three visible reference points connected to the body suit;
a conversion module configured to convert the plurality of images into a three-dimensional model of the user by determining contours of the user from the plurality of images and the corresponding reference points in each image; and
a presentation module configured to present the three-dimensional model to the user in an interface that allows the user to clothe the model in a plurality of selectable garment representations, the garment representations fitting on the model based on the respective sizes of the three-dimensional model and the selectable garment representations.

2. The apparatus of claim 1, wherein the conversion module determines the contours and generates the three-dimensional model using a commercially available software package.

3. The apparatus of claim 1, wherein the conversion module converts the plurality of images from a corresponding set of photographic film images captured using a disposable camera.

4. The apparatus of claim 1, further comprising a representation conversion module configured to generate a fabric pattern sized to proportionally correspond to the one or more selected garment representations on the three-dimensional model, wherein the fabric pattern is printed to minimize fabric waste and configured such that a seamstress can follow the pattern and make the corresponding garment.

5. The apparatus of claim 4, wherein the garment representations are representative of custom-tailored garments such that the garment representations are sized to properly fit the three-dimensional model according to the size of the portions of the three-dimensional model within the garment representation.

6. The apparatus of claim 1, wherein the presentation module rotates the three-dimensional model to display different sides of the three-dimensional model including selected garment representations on the three-dimensional model in response to a user command, the presentation module further comprising adjustment points configured to change the configuration of the garment representation in response to a user moving one or more of the adjustment points.

7. A method for generating a three-dimensional model configured to represent a user, the method comprising:
receiving a plurality of images of a user wearing a form-fitting body suit, each image taken at a plurality of predetermined angles circumscribing the user, each image including at least three visible reference points connected to the body suit;
determining contours of the user based on the plurality of images and the corresponding reference points in each image; and
generating a three-dimensional model of the user from the contours.

8. The method of claim 7, wherein determining the contours and generating the three-dimensional model are performed by a commercially available software package.

9. The method of claim 7, further comprising converting a plurality of corresponding photographic film images captured using a disposable camera into the plurality of images.

10. The method of claim 7, wherein the three-dimensional model includes the head, feet, and arms of the user, the method further comprising:
displaying the three-dimensional model to the user in an interface that allows the user to clothe the model in a plurality of selectable garment representations;
displaying one or more selected garment representations on the three-dimensional model, in response to a user command.

11. The method of claim 10, further comprising generating a fabric pattern sized to proportionally correspond to the sizes of the one or more selected garment representations on the three-dimensional model, wherein the fabric pattern is printed to minimize fabric waste and configured such that a seamstress can follow the pattern and make the corresponding garment.

12. The method of claim 10, wherein the garment representations are representative of custom-tailored garments such that the garment representations are sized to properly fit the three-dimensional model according to the size of the portions of the three-dimensional model within the garment representation.

13. The method of claim 10, wherein the interface rotates the three-dimensional model to display different sides of the three-dimensional model including selected garment representations on the three-dimensional model in response to a user command, the interface further comprising adjustment points configured to change the configuration of the garment representation in response to a user moving one or more of the adjustment points.

14. A method for providing custom-tailored clothing, comprising:
sending an image capture kit to a customer for capturing a plurality of two-dimensional images of a user wearing a form-fitting body suit having a plurality of reference points, each image taken within about the same horizontal plane and from a different angle circumscribing the user;
receiving the plurality of images from the customer and rendering a three-dimensional model configured to represent the customer from the images, the three-dimensional model comprising the actual size, likeness, and proportions of the user wearing the body suit; and
presenting the three-dimensional model dressed in a representation of a user-selected garment to the customer, the representation of a user-selected garment draping naturally over the three-dimensional model in accordance with the proportions of the representation of a user-selected garment.

15. The method of claim 14, further comprising:
converting the representation of a user-selected garment into a fabric pattern for making a custom-tailored garment;
sending the fabric pattern to a tailoring facility; and
making the custom-tailored garment from the fabric pattern.

16. The method of claim 15, wherein the three-dimensional model dressed in a user-selected garment is presented using a computer network, the method further comprising:
conducting a sales transaction to purchase the custom-tailored garment over the computer network; and
sending the custom-tailored garment directly from the tailoring facility to the customer.

17. The method of claim 16, wherein the three-dimensional model dressed in a representation of a user-selected garment is presented in a web browser and the sales transaction is conducted over the Internet.

18. The method of claim 14, the image capture kit comprises a form-fitting body suit and one or more of a disposable camera, a set of fabric swatches, and a turn-table marked with a plurality of angles such that the user remains in the same position on the turn-table for each image and the turn-table is successively rotated to one of the plurality of angles in relation to the camera.

19. The method of claim 14, wherein a commercially available software package renders the three-dimensional model.

20. The method of claim 14, wherein the fabric pattern comprises a digital set of instructions for computer aided machinery (CAM).
